(19) United States
(12) Patent Application Publication
(10) Pub. No.: US 2026/0230784 A1
(43) Pub. Date: Aug. 6, 2026

(54) Method of vehicle mounted relaying

(71) Applicant: CONTINENTAL AUTOMOTIVE TECHNOLOGIES GMBH, Hannover (DE)

(72) Inventors: Andreas Andrae, Frankfurt am Main (DE); Rikin Shah, Langen, Hessen (DE); Reuben George Stephen, Singapore (SG); David Gonzalez Gonzalez, Egelsbach, Hessen (DE)

(73) Assignee: CONTINENTAL AUTOMOTIVE TECHNOLOGIES GMBH, Hannover (DE)

(21) Appl. No.: 19/153,306

(22) PCT Filed: Feb. 13, 2024
(86) PCT No.: PCT/EP2024/053568

§ 371 Date: Aug. 1, 2025

(30) Foreign Application Priority Data
Feb. 15, 2023 (DE) 10 2023 201 306.1

(51) Int. Cl. H04W 4/44; H04W 88/04

(52) U.S. Cl. CPC H04W 4/44; H04W 88/04

(57) ABSTRACT

A method for vehicle mounted relaying in wireless communications, by a plurality of user equipments (UEs) including at least one vehicle mounted UE able to exchange data in a wireless network with remote user equipments via a Relay UE. The method includes: (first step) Relay UE indicates vehicle-mounted UE characteristics and capabilities to network and to remote user equipments, (second step) Relay UE detects vehicle occupants as onboard remote user equipments, provides the network with assistance information regarding onboard remote UEs, and the network determines and/or adjusts measurement configurations of the onboard remote UEs, (third step) based on the received UE characteristics and capabilities, the network provides configurations and/or updates pre-configurations of relay UEs candidates for relay re-selection, (fourth step) the network authorizes and/or configures the Relay UE for locally managing radio resources and Quality of Service (QOS).

This application is the U.S. National Phase Application of PCT International Application No. PCT/EP2024/053568, filed Feb. 13, 2024, which claims priority to German Patent Application No. 10 2023 201 306.1, filed Feb. 15, 2023, the contents of such applications being incorporated by reference herein.

### TECHNICAL FIELD OF THE INVENTION

The present disclosure relates to method of vehicle mounted relaying for wireless communications.

### BACKGROUND OF THE INVENTION

The techniques disclosed in this description relates to cooperative vehicle mounted relaying in wireless communication, where wireless devices cooperate to transmit signals over the air in a new, distributed form of spatial diversity.

US 2004266339 A1, incorporated herein by reference, discloses wireless networks using cooperative relaying which in a communication session involve more than one relay station. In the method according to the present invention, a transmitter, a receiver and at least one relay station are engaged in a communication session. The relay station forwards signals from a first link between the transmitter and the relay station to a second link between the relay stations and the receiver. The relay station forwards the signal with the use of a relative transmission parameter and optionally a common transmission parameter. The relative transmission parameter is determined locally in each relay station and based on a characterization of a first link, or the second link or a combination of the first and second link.

US 2017238275 A1, incorporated herein by reference, discloses communication devices in a telecommunications network suitable for providing assistance in supporting other communication devices in comparatively poor radio coverage. The telecommunications network is dynamically adapted to improve overall network performance without requiring the introduction of new network equipment by determining how these communication devices are to be activated/deactivated and maintained. In one example, the dynamic activation/maintenance of the radio coverage assistance serves to reduce problems associated with users at the cell edge, resulting in improvements in overall cell capacity.

US 2011199919 A1, incorporated herein by reference, discloses methods and apparatuses that facilitate associating with relays in a wireless network. A device can select whether to utilize relay assistance where present based at least in part on measuring one or more determined or projected parameters related to the relay. Where utilizing a relay results in user-plane data channel conditions above a threshold level and control channel conditions below a threshold level, a serving base station can determine whether to employ another base station to serve the device, jointly serve a relay with an additional base station, and/or the like.

US 2016192439 A1, incorporated herein by reference, discloses processes related to discovering and establishing suitable multi-hop communication paths for (endpoint) user equipments (UEs). A network-initiated discovery and path selection processes may utilize periodically transmitted reference signals along with optional assistance information. A network node, such an eNodeB, and other relaying-capable nodes, such as relay UEs, may transmit periodic reference signals. Based on these transmitted reference signals and optional assistance information, the relay UEs and/or an endpoint node (e.g., the eNodeB or the endpoint UE) may make a selection decision for previous hop paths for communication. The endpoint UE or the eNodeB may make the selection decision for the end-to-end path in order to provide coverage extension for the end UE using multi-hop transmission paths.

US 2013040558 A1, incorporated herein by reference, discloses a method in a target node for handling capabilities of a wireless relay in a communications network. The target node receives, from the wireless relay, information indicating a capability of the wireless relay. The information indicates whether the wireless relay is fixed or movable. Based on the received information, the target node determines a procedure to be executed, which procedure is dependent on whether the wireless relay is fixed or movable.

US 2011117907 A1, incorporated herein by reference, discloses a method and a controller for selecting the type of connection used to connect a terminal device to a serving base station. The connection type is selected on the basis of monitored communication-environmental parameters of the terminal device. The selection is made between a direct cellular radio connection and a relayed cellular radio connection. The relayed connection is established through another terminal device acting as a relay terminal for the connection being relayed. A direct device-to-device link between the two terminal devices is established as a cognitive radio connection, and a radio access technology and communication parameters of the device-to-device link may be negotiated between the terminal devices. The relay terminal then links the device-to-device link to a direct cellular radio connection between the relay terminal and the serving base station.

US 2019281526 A1, incorporated herein by reference, discloses systems, methods, and instrumentalities for a WTRU to act as a mobile relay, the method comprising the WTRU connecting to the network, the WTRU receiving a message from the network indicating that the WTRU is to act as a mobile relay for one or more devices outside of the coverage of the network, the WTRU discovering one or more devices outside of the coverage of the network, and the WTRU receiving a message from the out-of-coverage device that indicates that the out-of-coverage device has selected the WTRU to act as a mobile relay.

US 2019261443 A1, incorporated herein by reference, discloses a master user equipment (UE) device that coordinates device-to-device (D2D) communications amongst a plurality of UE devices. For example, a UE device, which has been designated as a master UE device, may coordinate a D2D communication between a first UE device and a second UE device. The master UE device may be a UE device that obtains an indication that it is a master UE device that is to coordinate D2D communications amongst the plurality of UE devices. In some embodiments, the coordinating the D2D communication may be on behalf of a network and/or to facilitate wireless communication between the network and at least one of the plurality of UE devices.

US 2022361076 A1, incorporated herein by reference, discloses a mechanism of relay UE discovery and relay UE selection and reselection for remote UE data transmission with a serving base station via relay UE. A method operable for relay UE selection and reselection of remote UE is provided. The UE considers additional criteria such as relay load other than purely radio signal quality (e.g., RSRP) criteria. The relay load can serve different purpose for relay UE and remote UE. The relay load can be the criteria for UE to become a relay UE or not. It can be the criteria for a remote UE to select another UE as its relay UE.

US 2017099690 A1, incorporated herein by reference, discloses a method and a controller to control not only cellular radio connections in a cell of a cellular communication system but also direct device-to-device communication links established between terminal devices within the cell. Particularly, the controller selects portion of the terminal devices to function as relay terminals for the other terminals to enable relayed communication links between the terminal devices and the base station through the relay terminals. The relay terminals link device-to-device connections to the cellular radio connections between the relay terminals and the base station.

US 2014220970 A1, incorporated herein by reference, discloses systems, methods for providing efficient and reliable communication for wireless devices, e.g., machine type communication devices, in a cellular communications network. In one embodiment, a node of a cellular communications network is configured to select a device-anchor base station for a wireless device from candidate device-anchor base stations, where the candidate device-anchor base stations are wireless devices that satisfy one or more predefined criteria for serving as a candidate device-anchor base station and establish a connection between the wireless device and the device-anchor base station for the wireless device such that data transmissions between the wireless device and a base station of the cellular communications network are via the device-anchor base station. In this manner, communication between the wireless device and the base station is assisted by the device-anchor base station.

EP 3618391 A1, incorporated herein by reference, discloses a relay discovery and relay forwarding method and device and a storage medium. The relay discovery and relay forwarding method comprises: performing a relay discovery operation; discovering a relay device that carries out relay and forwarding for a source device; sending a data packet to the relay device; and forwarding the data packet to a target device by means of the relay device.

WO 2021185960 A1, incorporated herein by reference, discloses a user device, UE, for a wireless communication system. The wireless communication system included a plurality of user devices, UEs. The UE (UE-A) is to communicate with one or more further UEs (UE-B) using a sidelink interface, SL, like a PCS interface. The UE (UE-A) is to send to the further UE (UE-B) one or more reports or assistance information messages, AIMs, to provide the further UE (UE-B) with one or more of the following: resource allocation related assistance information, link related assistance information, distance related assistance information, geographical area related assistance information, group related assistance information, relay related assistance information.

WO 2022027233 A1, incorporated herein by reference, discloses systems, methods, apparatuses, or computer-readable media for relay service. A second wireless communication device in a vicinity of a first wireless communication device may receive information to be used for selection of a relay device. The second wireless communication device may determine whether to wirelessly connect with the first wireless communication device as the relay device.

Also, some relaying techniques are disclosed by the patent applications DE 102022202050, WO2023006546 and WO2022238415 incorporated herein by reference.

Summarizing, the prior art describes the use of UE assistance information and the exchange of additional Relay UE information is anticipated.

The Third Generation Partnership Project (3GPP) has recently published its Releases 17 and 18 (2022-12, 2023-09) that include sidelink relaying and sidelink enhancement. The key difference between the two is that while sidelink relays extend network coverage through a wireless device acting as a network node, sidelink enhancement refers to the extension of device-to-device communication (D2D) to other use cases besides Vehicle-to-Vehicle (V2V) or Vehicle-to-Architecture (V2A).

Sidelink relaying in 3GPP is rooted in the framework for “Proximity Services” (ProSe) and elaborated further at NR sidelink relaying procedures of the technical standard TS 38.331, V17.2.0 (2022-09), Section 5.8.3 and 5G Sidelink Relaying Discovery procedures of the technical standard 3GPP TS 23.304V 18.0.0 ., Sections 5.2.3 (5G ProSe UE-to-Network Relay Discovery) and 5.2.5 (5G ProSe UE-to-UE Relay Discovery). For both UE-to-Network or UE-to-UE Relay discovery standard procedures, both Model A (announcing, «I am here») and Model B (soliciting a response and responding, «Who is there?/Are you there? ») are supported.

A significant shortcoming of the above discussed prior art is that, initially, the concept of “relay” nodes was introduced for addressing coverage (e.g., at cell edge) or capacity issues. However, for service design and optimization, the mobile network operators needs to be able to differentiate between relay nodes and be aware of relay node capabilities and characteristics. Another issue is that, even the network may configure an user equipment to report measurements for selection or authorization purpose, any measurements performed by the user equipment drain power from battery, and solely measurements are not sufficient as to improve service continuity, additional assistance information is needed. In addition, sidelink relaying depends on (pre-)configured sidelink resources; there are instances where this limitation impacts quality of service.

Therefore, an aspect of the invention aims to address the problematic questions of how to differentiate between relay UEs? How to improve idle mode mobility and energy consumption for remote UEs that are co-located within a vehicle for a longer time period? How to enable service continuity when switching from one mobile relay UE to another one? And, most important, how to improve quality of service QoS for remote UEs? Or, to sum up, the technical problem is how to influence or improve the relay selection, re-selection and/or relay authorization.

### SUMMARY OF THE INVENTION

A first aspect of the invention relates to a method for vehicle mounted relaying in wireless communications, by a plurality of user equipments UEs including at least one vehicle mounted UE able to exchange data in a wireless network with remote user equipments via a Relay UE. The method comprises the following steps:
First step: the Relay UE indicates vehicle-mounted UE characteristics and capabilities to network and to remote user equipments,
Second step: the Relay UE detects vehicle occupants as onboard remote user equipments, provides the network with assistance information regarding onboard remote UEs, and the network determines and/or adjusts measurement configurations of the onboard remote UEs,
Third step: based on the received UE characteristics and capabilities, the network provides configurations and/or updates pre-configurations of relay UEs candidates for relay re-selection,
Fourth step: the network authorizes and/or configures the Relay UE for locally managing radio resources and Quality of Service (QOS).

Main benefits of associating user equipments with vehicle occupancy in vehicle mounted relaying scenarios are an improved service continuity, enhanced relay selection or switch procedures (in particular indirect-to-indirect path switch). Further, awareness of available vehicular relay nodes enables network operators to improve access to services as well as to offer new services. In particular, relay nodes embedded in public transportation vehicles (e.g., buses, shuttles), which may also exhibit a recurring mobility pattern, enables mobile network operators to establish new business with fleet operators or mobility service providers by providing connectivity via vehicular relay nodes. Further, a vehicular relay node may be particularly suitable to act as both UE-to-network and UE-to-UE relay simultaneously (addressing coexistence issue).

Another aspect of the disclosure relates to a communication unit connected to a wireless network node, said communication unit comprising a processor coupled to a memory comprising computer program instructions stored thereon, said processor being configured by said instructions to perform the method according an aspect of the invention.

Another aspect of the disclosure relates to a user equipment connected to a wireless network, wherein the user equipment comprises a communication unit configured to perform the method according an aspect of the invention.

A further aspect contemplates a computer-readable information medium comprising computer program instructions for implementing steps of the method mentioned hereinabove.

A further aspect relates to a vehicular relay node connected to a wireless network comprising a processor coupled to a memory comprising computer program instructions stored thereon, said processor being configured by said instructions to perform the method mentioned hereinabove.

The advantages of the user equipment, vehicular relay node, wireless system, computer program and information medium are identical to those presented in relation with the corresponding method according to any one of the embodiments mentioned hereinabove.

### BRIEF DESCRIPTION OF THE DRAWINGS

Other advantages and characteristics of aspects of the invention will be more clearly apparent on reading the following description, given by way of simple illustrative and nonlimiting example, and the appended drawings, among which:

FIG. 1 illustrates the standard transmitting sidelink UE information for NR sidelink communication/discovery;

FIG. 2 shows the standard UE-to-network relaying,

FIG. 3 shows the standard UE-to-UE relaying,

FIG. 4 shows a general scenario of V2X UE-to-Network Relaying,

FIG. 5 shows a general scenario of V2X UE-to-UE Relaying,

FIG. 6 shows a general scenario of V2X Remote UE Mobility,

FIG. 7 shows an initial stage of V2X Inter-Relay Mobility scenario,

FIG. 8 shows a final stage of V2X Inter-Relay Mobility scenario,

FIG. 9 shows an overall flowchart of a method of vehicle mounted relaying, according to an aspect of invention,

FIG. 10 shows the overall flowchart with two options, in order to illustrate the inventive concept,

FIG. 11 shows an example of UE to Network/BS interaction between user equipment and network/base station according to embodiments of the present disclosure,

FIG. 12 shows an example of UE-to-Network Relaying according to embodiments of the present disclosure,

FIG. 13 shows an example of UE-to-UE Relaying according to a ProSe Model A embodiment of the present disclosure,

FIG. 14 shows a continuation of the example from FIG. 13,

FIG. 15 shows an example of UE-to-UE Relaying according to a ProSe Model A embodiment of the present disclosure,

FIG. 16 shows an alternative example of UE-to-UE Relaying according to a ProSe Model B embodiment of the present disclosure,

FIG. 17 shows an example of idle mode mobility and energy consumption of Remote UEs, according to embodiments of the present disclosure,

FIG. 18 shows a further example of Indirect-to-Indirect Path Switch between Relay UEs (idle mode mobility), according to embodiments of the present disclosure,

FIG. 19 shows another example of Indirect-to-Indirect Path Switch between Relay UEs (idle mode mobility) with server, according to embodiments of the present disclosure,

FIG. 20 shows an example of UE-based QoS Management, according to embodiments of the present disclosure.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The non-limiting term “User Equipment” (UE) is used and refers to any type of wireless device communicating with a network node and/or with another UE in a cellular or mobile communication system. Examples of UE are target device, device-to-device (D2D) UE, machine type UE or UE capable of machine-to-machine (M2M) communication, PDA, PAD, tablet, mobile terminals, smart phone, laptop embedded equipped (LEE), laptop mounted equipment (LME), USB dongles, UE category MI, UE category M2, ProSe UE, V2V UE, V2X UE, etc.

Throughout this description, the term of “vehicle-mounted relay UE” is a vehicular (mobile) user equipment arranged for relaying a service between a wireless network and remote user equipments. In exchange for relay, a more general term “network node” is used and corresponds to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, mobile Integrated Access and Backhaul, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

Additionally, terminologies such as base station or ground base station gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

In the following disclosure, reference will be made to user equipment, vehicular mounted relay and wireless system described above.

For the sake of understanding in the figures some of the functional blocks are described textually.

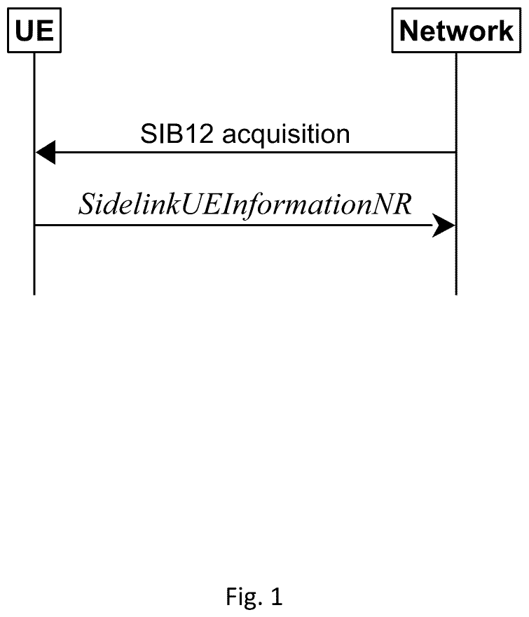

FIG. 1 shows the standard procedure of transmitting sidelink user equipment UE information for 5G New Radio (NR) sidelink communication/discovery according to the 3GPPP Technical Standard TS 38.331, V 17.2.0 (2022-09), Section 5.8.3. The purpose of this procedure covers several aspects, such as (among others): to inform the network that the user equipment is interested or no longer interested to receive or transmit the NR sidelink communication/discovery; to request assignment or release of transmission resource for NR sidelink communication/discovery; to report Quality-of-Service (QOS) parameters and profile(s) related to NR sidelink communication; to report the sidelink user equipment capability information of the associated peer user equipment for unicast communication, or to report parameters related to UE-to-network (U2N) relay operation. In other words, a UE capable of NR sidelink communication or NR sidelink discovery or NR sidelink U2N relay operation may initiate the procedure to indicate it is (interested in) receiving or transmitting the respective sidelink communication or discovery or operation in several cases including: upon successful connection establishment or resuming, change of interest, changing QoS profiles, receiving UECapabilityInformationSidelink message from the associated peer UE, etc. Furthermore, the network configures the UE to perform measurements, and to report them in accordance with the measurement configuration or to perform conditional reconfiguration evaluation. There are enumerated the following types of measurements:
NR measurements;
Inter-RAT measurements of E-UTRA frequencies;
Inter-RAT measurements of UTRA-FDD frequencies;
NR sidelink measurements of L2 U2N Relay UEs.

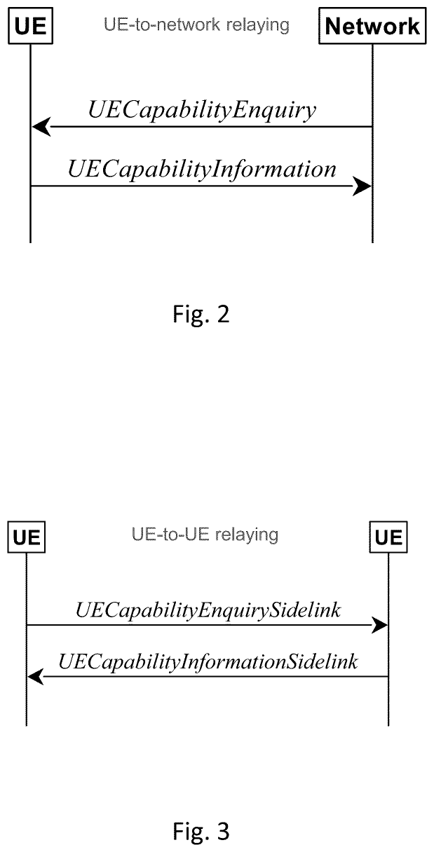

FIG. 2 shows the standard UE-to-network (U2N) relaying. The network initiates the procedure at connected UE (RRC_CONNECTED in Radio Resources Control protocol) when it needs (additional) UE radio access capability information.

FIG. 3 shows the standard UE-to-UE relaying. The UE initiates the sidelink UE capability transfer procedure upon indication from upper layer when it needs (additional) UE radio access capability information.

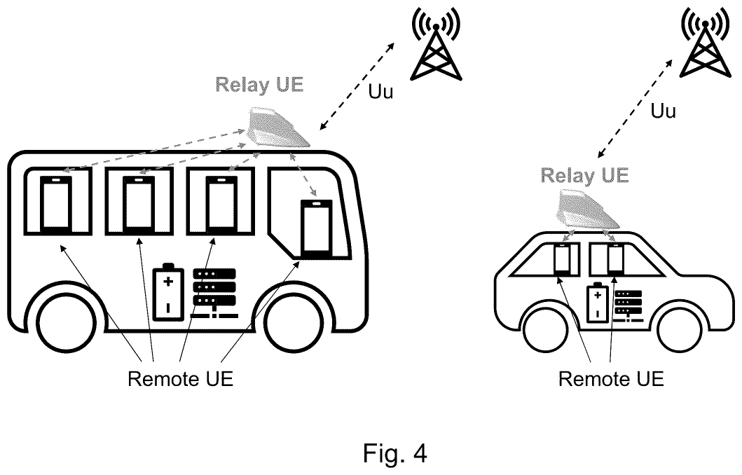

FIG. 4 shows the UE-to-Network Relaying in the context of an aspect of invention, where a vehicle mounted Relay UE acts as a mobile network node (or a mobile base station integrated access and backhaul), and provides coverage and capacity enhancement to onboard UEs. In this scenario, the onboard UEs are being provided with network coverage by means of a vehicle mounted relay UE and an air interface Uu.

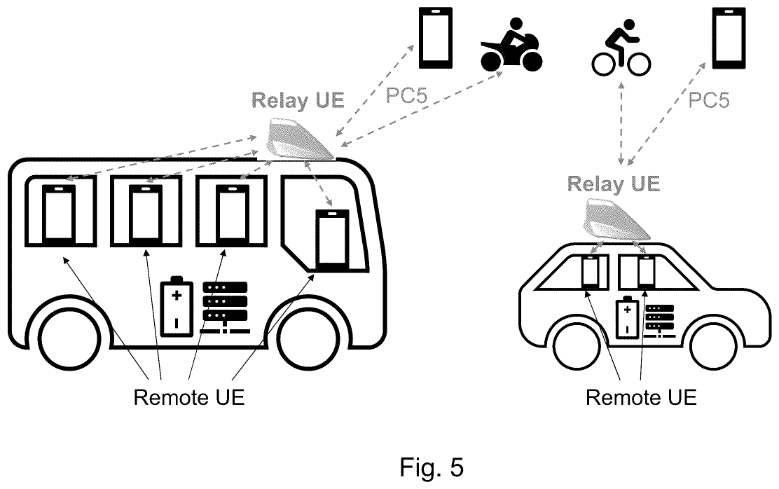

FIG. 5 shows the UE-to-UE Relaying in the context of an aspect of invention, where a vehicle mounted relay UE acts as a mobile network node (or a mobile base station integrated access and backhaul), and provides coverage and capacity enhancement to onboard UEs and/or surrounding UEs (non-onboard).

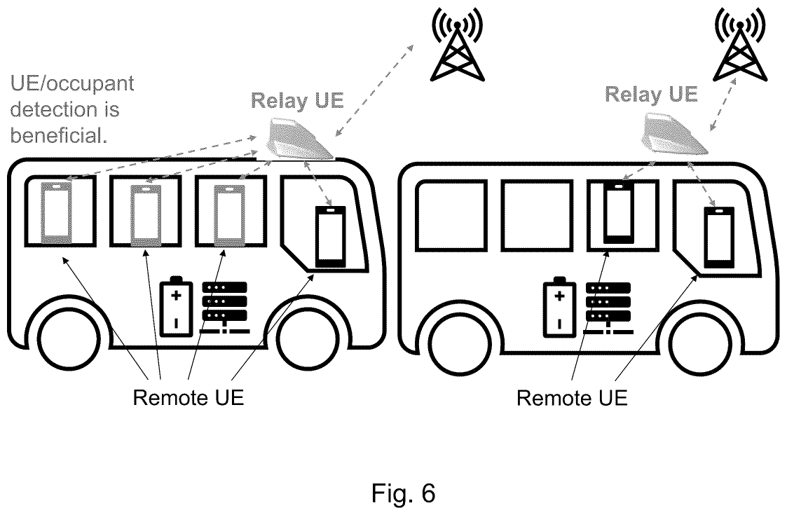

FIG. 6 shows the scenario of Remote UE Mobility in the context of an aspect of invention, where remote user equipment is detected in association with vehicle occupants.

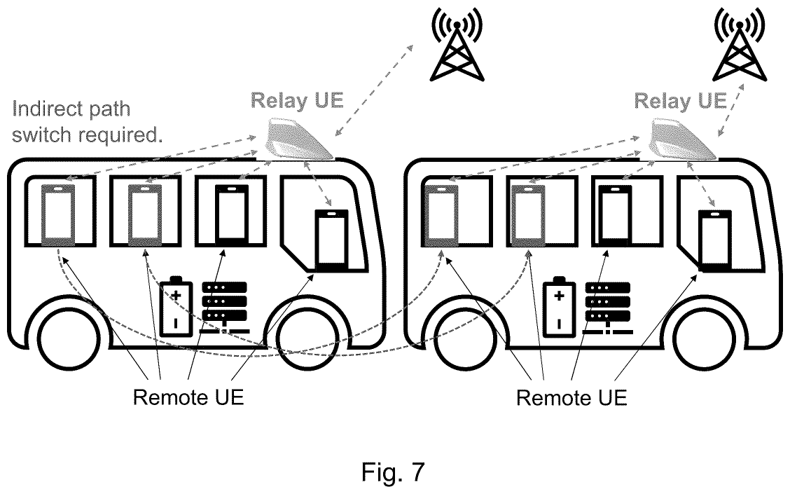

Furthermore, FIG. 7 shows how, by this association, it is possible to require the transfer of network coverage inter-relays (for example, when the occupants of a fist vehicle get onboard a second vehicle, bringing along their respective user equipments, an indirect-to-indirect (i2i) path switch is required from the relay UE mounted on the first vehicle to the relay UE mounted on the second vehicle).

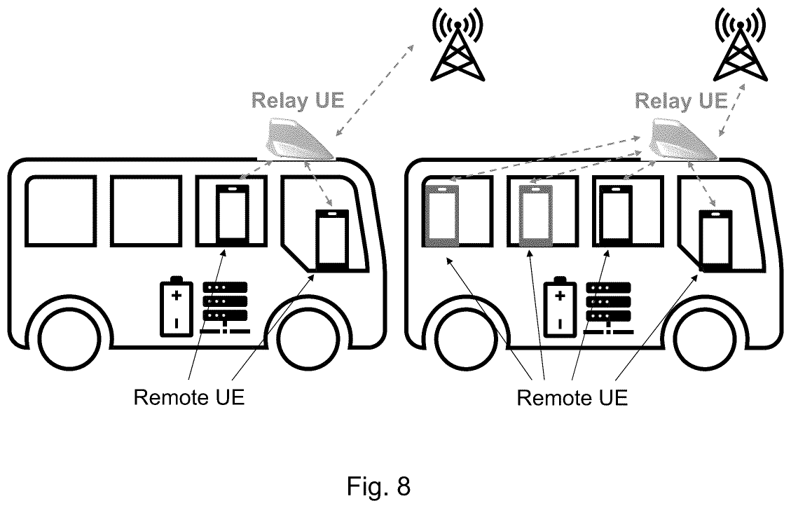

FIG. 8 illustrates the final result of inter-relay mobility scenario, where the remote user equipments associated with occupants changing vehicles are still covered by the same network, but connected via the respective vehicles mounted relays and using sidelink to transfer user equipment capability.

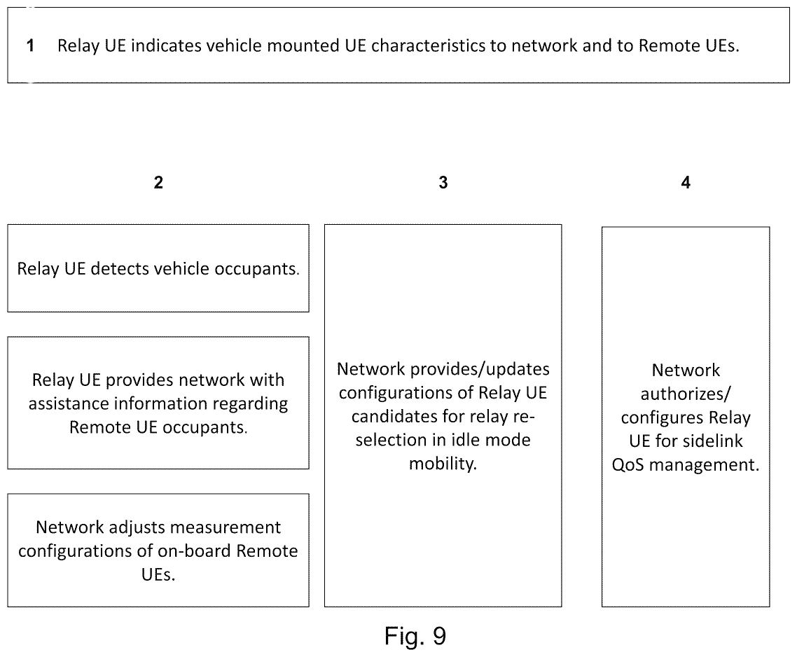

FIG. 9 shows an overall flowchart of a method of vehicle mounted relaying, according to an aspect of invention. Let's assume a vehicle is equipped with at least one user equipment capable to exchange data between any other user equipment and a wireless network via a Relay UE. The user equipment mounted on vehicle is called a vehicle mounted UE, the rest of user equipments (i.e., not vehicle mounted and not the Relay UE) are called Remote UEs.

In a first step of the method, the Relay UE indicates vehicle-mounted UE characteristics and capabilities to network and to remote UEs.

In a second step, the Relay UE detects vehicle occupants, meaning onboard Remote UEs, and provides the network with assistance information regarding the detected vehicle occupants' Remote UEs (onboard Remote UEs). The network determines and/or adjusts measurement configurations of onboard Remote UEs, based on the assistance information provided by Relay UE.

Following the first step, but independently of the second step, in a third step, based on the received UE characteristics and capabilities, the network provides configurations and/or updates pre-configurations of relay UEs candidates for relay re-selection.

Following the first step, but independently of the second or third step, in a fourth step, in response to the vehicle mounted UE characteristics provided by the Relay UE, the network authorizes and/or configures the Relay UE for locally managing radio resources and Quality of Service (QOS).

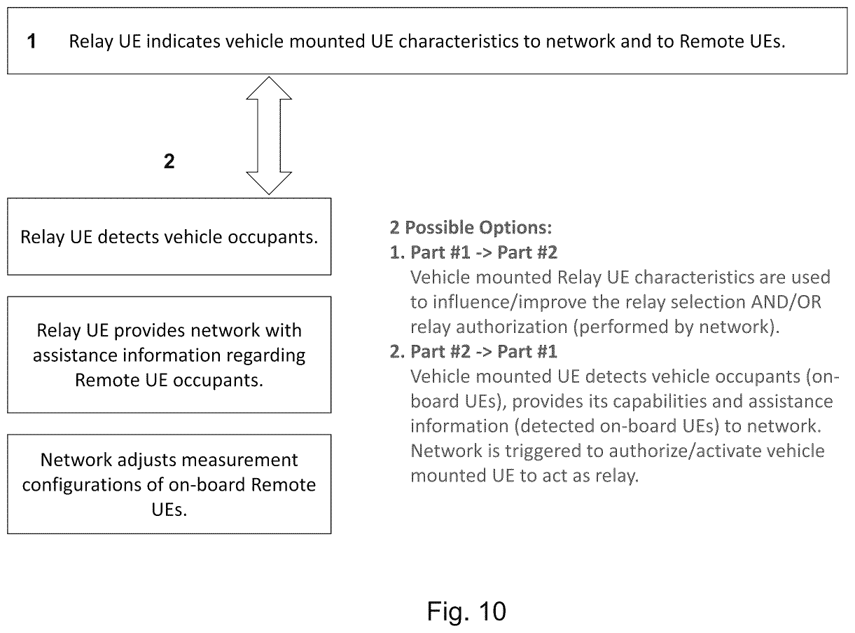

FIG. 10 shows the overall flowchart of the method, illustrating two possible options of exchanging data between vehicle mounted UE and network:
a first option where the vehicle mounted UE characteristics and capabilities are used in relay selection and/or authorization, performed by the network; and a second option where the vehicle mounted user equipment detects vehicle occupants, meaning onboard UEs, and provides the capabilities and assistance information of the detected onboard UEs to the network. Based on the provided data, the network is triggered to authorize or to activate vehicle mounted UE to act as relay.

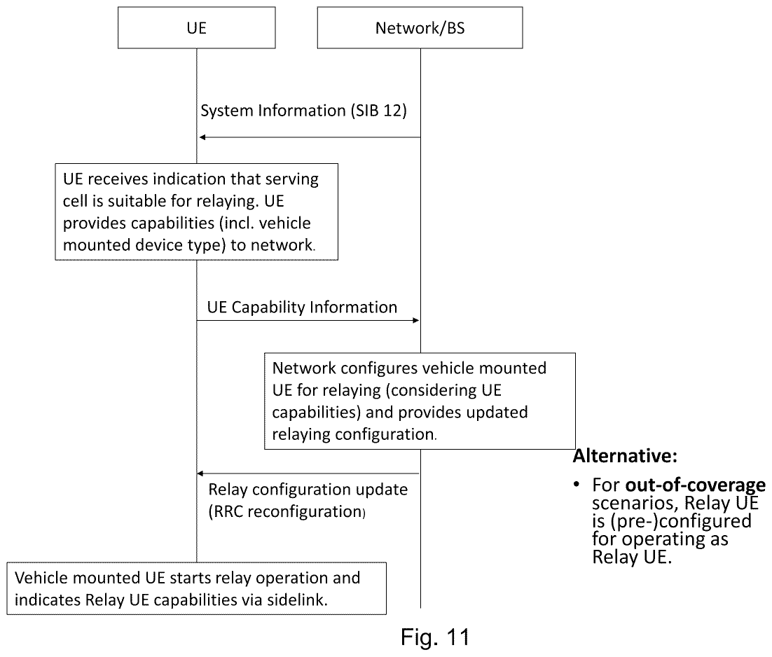

FIG. 11 shows an example of UE to Network/BS interaction between user equipment and network/base station according to an embodiment of the present disclosure, namely the step of a Relay UE indication and discovery.

When one vehicle mounted UE registers to the network, the network enquires the respective user equipment to obtain and identify its capabilities including: sidelink or mobile Integrated Access and Backhaul relaying, vehicle mounted device type, computing capabilities, battery type, node type, antenna capabilities (for example, by means of UECapabilityInformation message, UECapabilityInformationSidelink message that includes these additional assistance information).

The network configures relay-capable UEs to act as Relay UE, depending on reported device capabilities and/or battery type. Radio Access Technology (RAT) for relay operations is either pre-configured, e.g., PC5 or determined by the Relay UE. The network configures the Relay UEs to indicate vehicle mounted device type to network and other UEs via sidelink signaling. “Vehicle mounted device type” is selected from a list of “device types” or “device profiles”. For example, vehicle mounted device type #1 is characterized by being able to employ higher transmit power (i.e., higher power class UE) and/or provide higher antenna gain (compared to smartphone type UEs). Vehicular UEs that exhibit special characteristics are preferably chosen or authorized to act as relay UE (special characteristics being e.g., larger battery thus longer lifetime acting as relay, on-board computing capabilities, sophisticated antenna systems).

For out-of-coverage scenarios, the vehicle mounted UE is preconfigured for operating as Relay UE.

When vehicle-mounted UE registers to network, the UE indicates its characteristics and capabilities to the network, including sidelink and/or mobile Integrated Access and Backhaul relaying, vehicle mounted device type, computing and antenna capabilities, and battery type, the network configures relay-capable UEs to act as Relay UE and/or mobile Integrated Access and Backhaul node depending on reported device characteristics and capabilities.

The network's support for the vehicle mounted relay UE comprises a series of sub-steps, namely: in response to receiving a system information message (SIB1, for example), determining based on pre-configuration and UE capabilities that the UE is configured and capable of operating as relay UE and/or mobile Integrated Access and Backhaul node, requesting network connection setup. In response to receiving a connection setup message from the wireless communication system, providing node type indication as well as UE capabilities. In response to receiving node-specific configuration, applying received relay and/or mobile Integrated Access and Backhaul node configuration for operations.

Further, a vehicle-mounted UE is particularly suitable to act as UE-to-network and UE-to-UE relay. In some embodiments, a vehicle mounted UE is suitable to act as mobile base station Integrated Access and Backhaul node.

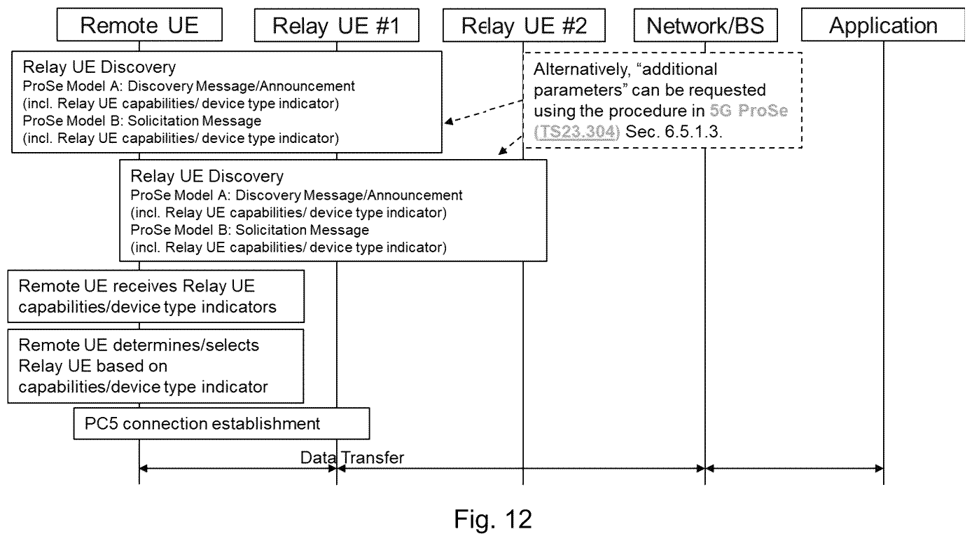

FIG. 12 shows the flowchart of the method's step of UE-to-Network Relaying, according to embodiments of the present disclosure supporting both 5G ProSe Model A and Model B.

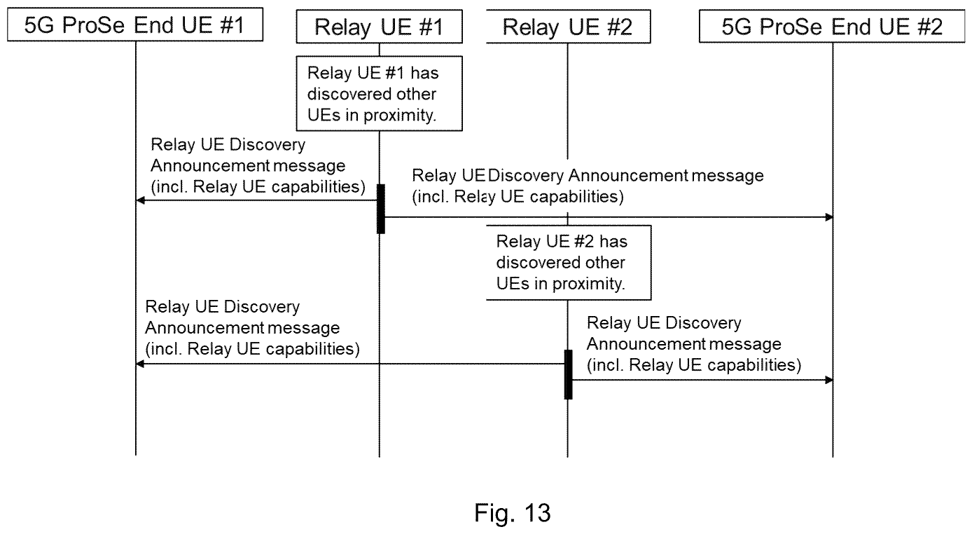

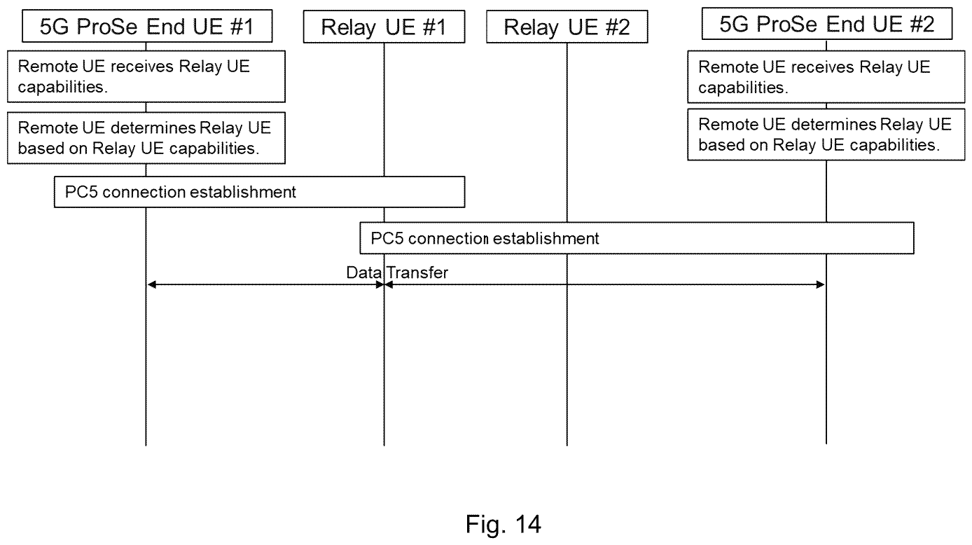

FIG. 13 shows an example of UE-to-UE Relaying according to a ProSe Model A embodiment of the present disclosure. More precisely, when a Relay UE #1 discovers other UEs (Remote UE #1 and Remote UE #2) in proximity, it sends a Relay UE Discovery Announcement message that includes also its own UE capabilities; the same proceeds a Relay UE #2 when discovers other UEs (Remote UE #1 and Remote UE #2) in proximity. FIG. 14 shows a continuation of the example from FIG. 13: each discovered Remote UE receives the respective Relay UE capabilities, determines Relay UE based on the received data (meaning the Relay UE capabilities) and establishes the suitable RAT for connection (for example, PC5)

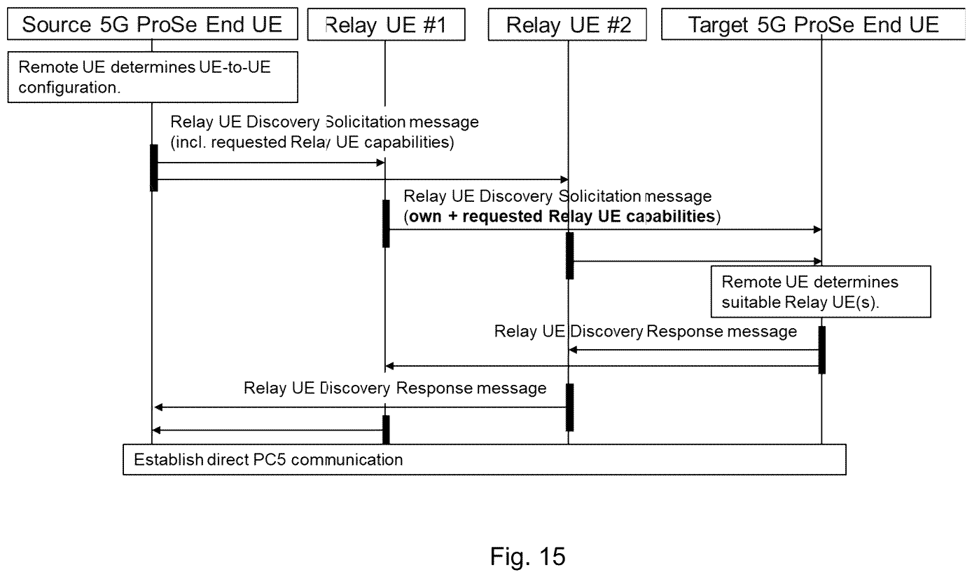

FIG. 15 shows an example of UE-to-UE Relaying according to a ProSe Model A embodiment of the present disclosure. In this case, a Source UE sends a solicitation message to Relay UE #1 and to Relay UE #2, the solicitation message including requested Relay UE capabilities; both Relay UE #1 and Relay #2 send respective solicitation messages to a target Remote UE, the solicitation message including their respective and requested Relay UE capabilities. Finally, once receiving both solicitation messages, the target Remote UE determines suitable Relay UE(s) and responds to both Relay UE #1 and Relay UE #2. Furthermore, both Relay UE #1 and Relay UE #2 send response messages back to the Source UE that establishes the suitable RAT (for example, PC5).

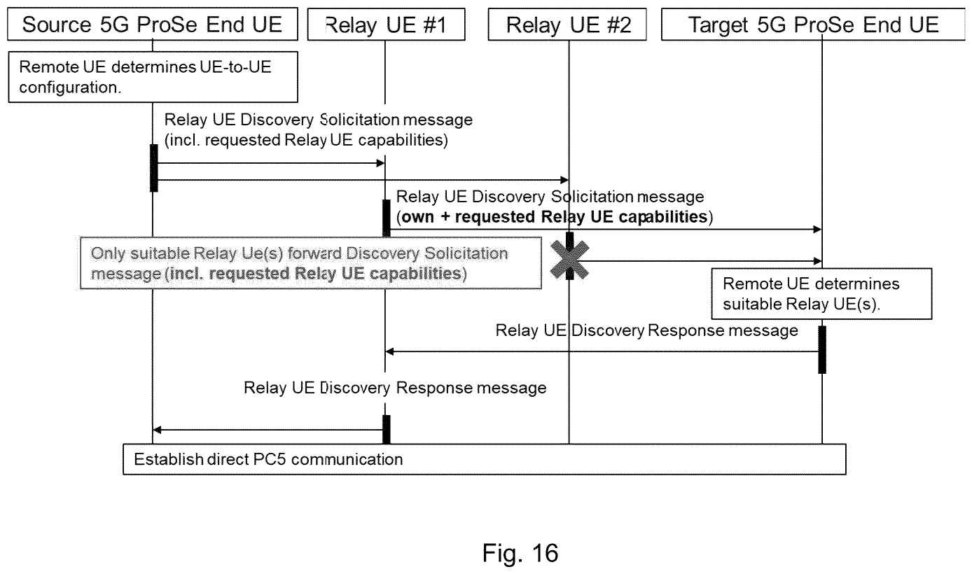

FIG. 16 shows an alternative example of UE-to-UE Relaying according to a ProSe Model B embodiment of the present disclosure. In this alternative example, only suitable Relay UE(s) forward the Discovery Solicitation message including their own and requested Relay UE capabilities. Therefore, this alternative example is advantageous, since the exchanged data is reduced.

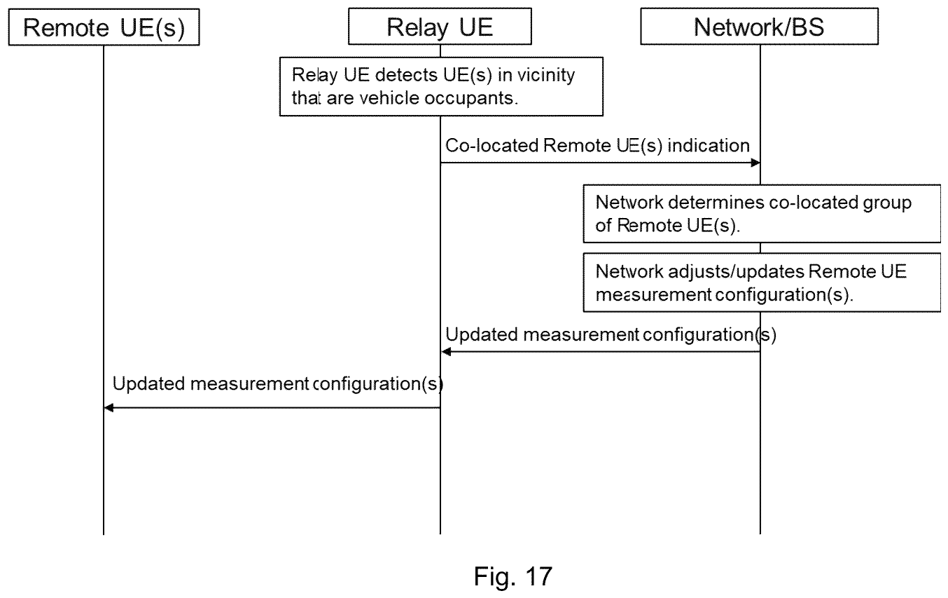

FIG. 17 shows an example of idle mode mobility and energy consumption of Remote UEs, according to embodiments of the present disclosure. The vehicle mounted Relay UE detects that connected Remote UEs are located in the same vehicle. For example, the Vehicle Mounted Relay UE estimates the Doppler shift of signals received from Remote UEs for determining co-location of Vehicle Mounted Relay UE and Remote UEs. As an alternative, a driver monitoring system or in-cabin monitoring system or sidelink signaling of mobility indicator by Remote UEs is detected. Vehicle mounted Relay UE indicates to network that the connected Remote UEs are co-located. The network changes and determines new (adjusted or updated, more relaxed) measurement configurations for connected Remote UEs. The network signals the new/updated measurement configurations to Remote UEs via Relay UE. Additional benefits of implementing the method is that the network becomes aware of the UE groups, e.g., onboard UEs, and groupcast and/or group-based indications or configurations could be optimized or used for further operations.

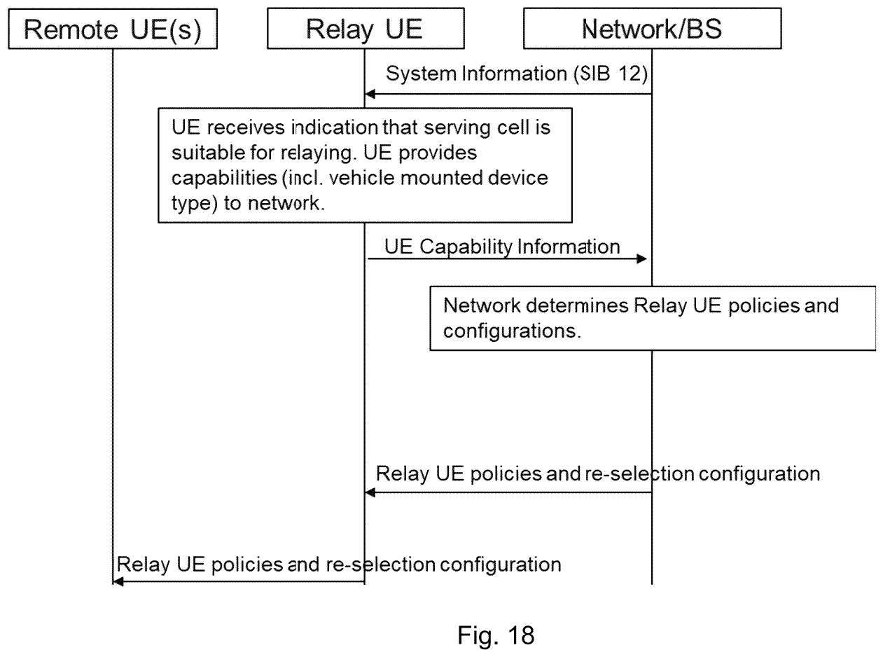

FIG. 18 shows a further example of Indirect-to-Indirect Path Switch between Relay UEs (idle mode mobility), according to embodiments of the present disclosure. In this case, the network or a base station (pre-)configures a list of Relay UE candidates, including vehicle mounted Relay UE candidates. Relay UE forwards this configuration to connected Remote UEs.

Remote UEs follow this configuration for relay re-selection in idle mode mobility. Further enhancement is that Indirect-to-Indirect path switch is triggered by Relay UE. Relay UE triggers the “i2i path switch procedure” (instead of being triggered by Remote UE measurements) enabling a relay-to-relay handover. The network (pre)configures indirect path configurations of Remote UEs, Relay UE forwards this configuration to connected Remote UEs, Remote UEs follow these configurations for performing indirect-to-indirect path switch procedure.

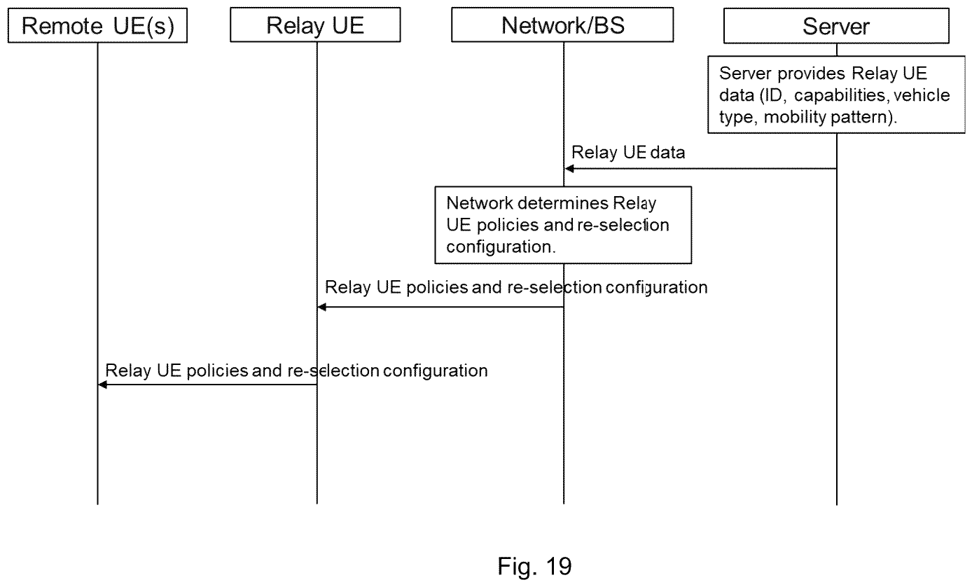

FIG. 19 shows another example of Indirect-to-Indirect Path Switch between Relay UEs (idle mode mobility) with server, according to embodiments of the present disclosure. The server provides Relay UE data (including identification ID, capabilities, vehicle type, mobility pattern). The network or a base station receives Relay UE data and, based on them, determines Relay UE policies and re-selection configuration. Further on, the network sends the Relay UE policies and re-selection configuration to Relay UE, that sends them to Remote UEs.

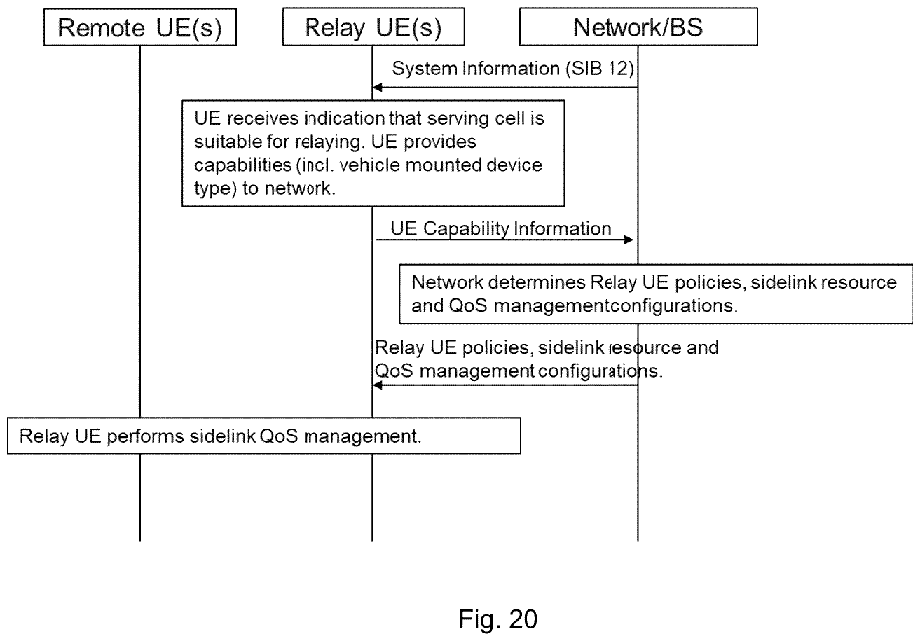

FIG. 20 shows an example of UE-based QoS Management, according to embodiments of the present disclosure. The vehicle mounted Relay UE is in charge of handling resources and QoS for sidelink UEs. For communications with remote user equipments, the Relay UE determines resources considering QoS flow-specific requirements, such as priority, bandwidth, and latency. For example, the Relay UE is a non-smartphone UE (for example, a vehicle mounted device or an aerial mobile device with less battery constraints compared to a smartphone UE). Thus, in addition to the third step, the following sub-steps are performed:
A new information in signaling is required, namely to determine smartphone UE or non-smartphone UE, all Remote UEs have to include this additional assistance information in the UE capability message.

A ground base station node gNB decides Relay UE policy based on the information received in the UE capability message. The ground node gNB provides the Relay UE configuration for sidelink resources and QoS management configuration.

Relay UE allocates sidelink resources based on Remote UE QoS requirements, and, if a certain load or resource utilization is detected, issues status reports to the network. Relay UE allocates sidelink resources based on Remote UE QoS requirements, and, if a certain load or resource utilization is detected, issues status reports to the network. For example, buffer status report of Relay UE indicating packet queue size, sidelink channel load, sidelink channel busy ratio, determined by Relay UE. The network uses such status report to adjust sidelink configuration and resources for Relay UE.

Consequently, an embodiment of the present disclosure relates to a computer program stored on an information medium, said program being suitable to be implemented in a communication unit, a user equipment and/or a vehicular relay node, or more generally in a computer, said program comprising instructions configured to implement steps of the method for vehicle mounted relaying by a user equipment which has just been described. The computer program can use any programming language, and be in the form of source code, object code, or of code intermediate between source code and object code, such as in a partially compiled form, or in any other desirable form. The information medium may be any entity or device capable of storing the program. For example, the medium can comprise a storage means, such as a ROM, for example a CD ROM or a microelectronic circuit ROM, FLASH memory or any magnetic recording means, for example a hard drive. Moreover, the information medium may be a transmissible medium such as an electrical or optical signal, which may be conveyed via an electrical or optical cable, by radio or by other means. Alternatively, the information medium may be an integrated circuit into which the program is incorporated, the circuit being adapted to execute or to be used in the execution of the method in question. In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. A method for vehicle mounted relaying in wireless communications, by a plurality of user equipments (UEs) including at least one vehicle mounted UE able to exchange data in a wireless network with remote user equipments via a Relay UE, the method comprising the following steps:
(first step) Relay UE indicates vehicle-mounted UE characteristics and capabilities to network and to remote user equipments,
(second step) Relay UE detects vehicle occupants as onboard remote UEs, provides the network with assistance information regarding the onboard remote UEs, and the network determines and/or adjusts measurement configurations of the onboard UEs,
(third step) based on the received UE characteristics and capabilities, the network provides configurations and/or updates pre-configurations of relay UEs candidates for relay re-selection, including candidates from vehicle mounted UEs
(fourth step) the network authorizes and/or configures the Relay UE for locally managing radio resources and Quality of Service (QOS).

2. The method according to claim 1, wherein the vehicle-mounted UE characteristics and capabilities are used for relay selection and/or relay authorization and/or relay configuration performed by network.

3. The method according to claim 1, wherein when the vehicle mounted UE
detects vehicle occupants as onboard user equipments, provides the detected onboard UEs' capabilities and assistance information to the network, and the network configures the vehicle mounted UE to act as relay.

4. The method according to claim 1, wherein in case the Relay UE detects and indicates to network that connected remote UEs are located in the same vehicle, the network determines and/or updates measurement configurations for connected remote UEs and the network provides new measurement configurations to remote UEs via Relay UE.

5. The method according to claim 1, wherein the method comprises a series of sub-steps indicating the network's support for the vehicle mounted Relay UE, namely: in response to receiving a system information message, determining based on pre-configuration and UE capabilities that the UE is configured and capable of operating as relay UE and/or mobile Integrated Access and Backhaul node, requesting network connection setup,
in response to receiving a connection setup message from the wireless communication system, providing node type indication as well as UE capabilities, and
in response to receiving node-specific configuration, applying received relay and/or mobile Integrated Access and Backhaul node configuration for operations.

6. The method according to claim 1, wherein the network configures Relay UEs to indicate vehicle mounted device type to network and other UEs via sidelink signaling, wherein UEs that exhibit special characteristics and capabilities, such as node type, on-board computing capabilities, sophisticated antenna systems, battery type, are chosen to act as relay UE and/or mobile Integrated Access and Backhaul node.

7. The method according to claim 1, wherein a vehicle mounted relay UE is suitable to act as mobile Integrated Access and Backhaul node, UE-to-network and UE-to-UE relay.

8. The method according to claim 1, wherein the vehicle mounted Relay UE
estimates the Doppler shift of signals received from the remote UEs for determining co-location of Vehicle Mounted Relay UE and Remote UE(s).

9. The method according to claim 1, wherein
a driver monitoring system or
in-cabin monitoring system or sidelink signaling by Remote UEs is detected and used to determine whether Remote UEs are on-board.

10. The method according to claim 1, wherein after the network configures the vehicle mounted UE to act as Relay UE, when the configured Relay UE detects a change in vehicle occupants as onboard user equipments that exceeds a threshold configured by the network, the Relay UE reports the change in detected onboard UEs, exceeding the configured threshold, to the network, and the network provides updated configuration to the Relay UE based on reported change in detected onboard UEs.

11. The method according to the claim 1, wherein when vehicle-mounted UE registers to network, the UE indicates its characteristics and capabilities to the network, including sidelink and/or mobile Integrated Access and Backhaul relaying, vehicle mounted device type, computing and antenna capabilities, and battery type, the network configures relay-capable UEs to act as Relay UE and/or mobile Integrated Access and Backhaul node depending on reported device characteristics and capabilities.

12. The method according to claim 1, wherein the network (pre)configures a list of Relay UE candidates, including vehicle mounted Relay UE candidates, Relay UE forwards this configuration to connected Remote UEs, Remote UEs follow this configuration for relay re-selection in idle mode mobility.

13. The method according to claim 1, wherein the network (pre)configures indirect path configurations of Remote UEs, Relay UE forwards this configuration to connected Remote UEs, Remote UEs follow these configurations for performing indirect-to-indirect path switch procedure.

14. The method according to claim 1, wherein when the Relay UE is in
charge of handling resources and QoS for communications with remote user equipments, the Relay UE determines resources considering QoS flow-specific requirements, such as priority, bandwidth, and latency.

15. The method according to claim 1, wherein the relay user equipment is a non-smartphone user equipment vehicle or aerial mobile device with less battery constraints compared to smartphone UE.

16. The method according claim 1, wherein at the fourth step, the following sub-steps are proceeded:
in order to determine smartphone UE or non-smartphone UE, all UEs include assistance information in the UE capability message;
a ground base station node (gNB) decides Relay UE policy based on the information received in the UE capability message;
the ground node base station (gNB) provides the Relay UE with configurations for sidelink resources and QoS management;
Relay UE allocates sidelink resources based on Remote UE QoS requirements, and, if a certain load or resource utilization is detected, issues status reports to the network.

17. A communication unit connected to a wireless network node, said communication unit comprising a processor coupled to a memory comprising computer program instructions stored thereon, said processor being configured by said instructions to perform the method according to claim 1.

18. A user equipment device connected to a wireless network node, said user equipment comprising a communication unit according to claim 17.

19. A wireless network node comprising a processor coupled to a memory comprising computer program instructions stored thereon, said processor being configured by said instructions to perform the method according to claim 1.

20. A mobile node connected to a wireless network node comprising a processor coupled to a memory comprising computer program instructions stored thereon, said processor being configured by said instructions to perform the method according to claim 1.

21. A wireless communication system comprising a wireless network node comprising a processor coupled to a memory comprising computer program instructions stored thereon and a mobile node according to claim 19 connected to the wireless network node comprising a processor for configuring a user equipment according to claim 18.

22. A non-transitory computer program product comprising instructions for implementing a method for vehicle mounted relay according to claim 1, when the program is executed by a processor.

23. A non-transitory computer-readable storage medium comprising computer program instruction stored thereon for implementing a method for vehicle mounted relay according to claim 1.

24. A non-transitory computer program product comprising instructions for implementing instructions for implementing a method in a user equipment according to the claim 17 when the program is executed by a processor.
